(19) United States
(12) Patent Application Publication
(10) Pub. No.: US 2026/0370295 A1
(43) Pub. Date: Nov. 19, 2026

(54) PHYSICAL UPLINK SHARED CHANNEL (PUSCH) ANTENNA PORT INDICATION FOR ENHANCED DEMODULATION REFERENCE SIGNAL (DMRS) TYPE 1

(71) Applicant: APPLE INC., Cupertino, CA (US)

(72) Inventors: Dan WU, Beijing (CN); Haitong SUN, Cupertino, CA (US); Wei ZENG, Saratoga, CA (US); Dawei ZHANG, Saratoga, CA (US); Hong HE, San Jose, CA (US); Jie CUI, San Jose, CA (US)

(73) Assignee: APPLE INC., Cupertino, CA (US)

(21) Appl. No.: 19/147,864

(22) PCT Filed: Feb. 15, 2023
(86) PCT No.: PCT/CN2023/076136

§ 371 Date: Jul. 14, 2025

(51) Int. Cl. H04B 7/06; H04L 5/00

(52) U.S. Cl. CPC H04B 7/0691; H04L 5/0016; H04L 5/0023; H04L 5/0051; H04L 5/0053

(57) ABSTRACT

Some aspects of this disclosure relate to apparatuses and methods for implementing mechanisms for indicating and using antenna ports for enhanced Demodulation Reference Signal (DMRS). For example, a UE can be configured to determine a set of antenna ports for the transmission of a demodulation reference signal (DMRS) based on information associated with a configuration type, information associated with a maximum number of symbols, and information associated with a rank number. The DMRS uses frequency division Orthogonal Cover Codes (FD-OCC) of length 4. The set of antenna ports includes one or more of a first subset of antenna ports, a second subset of antenna ports different from the first subset of antenna ports, or a combination of the first subset of antenna ports and a second subset of antenna ports.

### BACKGROUND

### Field

The described aspects generally relate to mechanisms for indicating and using antenna ports for enhanced Demodulation Reference Signal (DMRS).

### Related Art

Demodulation Reference Signal (DMRS) can be used by a receiver device to determine channel estimates and use the channel estimates for demodulation of an associated physical channel. DMRS can be specific to different physical channels. For example, DMRS can be specific to Physical Uplink Shared Channel (PUSCH), Physical Uplink Control Channel (PUCCH), Physical Downlink Shared Channel (PDSCH), Physical Downlink Control Channel (PDCCH), or the like. For a PUSCH operation, a user equipment (UE) can use one or more antenna ports to transmit DMRS. The antenna ports for legacy DMRS that the UE can use are provided in, for example, 3rd Generation Partnership Project (3GPP) Technical Specification (TS) 38.212 version 16.2.0 Release 16 (multiplexing and channel coding—ETSI TS 138 212 V16.2.0 (2020 July)) (also referred to as legacy antenna ports).

### SUMMARY

Some aspects of this disclosure relate to apparatuses and methods for implementing mechanisms for indicating and using antenna ports for enhanced Demodulation Reference Signal (DMRS). According to some aspects, by using the enhanced DMRS, the UE can be configured to use additional antenna ports in addition to the antenna ports indicated in TS 38.212. These additional antenna ports are also referred to as enhanced antenna ports in the disclosure. Additionally, or alternatively, the enhanced DMRS can increase the number of layers (number of layers is also referred to herein as rank) that the UE can use for transmitting DMRS. For example, the enhanced DMRS can increase the number of layers (e.g., the uplink layers) to eight layers. Therefore, the UE can be configured to use these additional antenna ports.

As discussed in more detail below, for the UE to determine which antenna port to use for transmitting the DMRS, the UE can receive, from the network (e.g., a base station), information associated with a maximum length for DMRS, information associated with a configuration type of the DMRS, and information associated with a number of layers to use for transmitting the DMRS. The UE can use these information in the enhanced DMRS to determine a table of antenna ports to use for transmitting the DMRS to the base station.

According to some aspects, antenna ports that the base station indicates to the UE for the enhanced DMRS can be from the legacy antenna ports (e.g., antenna ports indicated in TS 38.212—for example, Tables 7.3.1.1.2-8/9/10/11; Tables 7.3.1.1.2-12/13/14/15; Tables 7.3.1.1.2-16/17/18/19; and Tables 7.3.1.1.2-20/21/22/23 in TS 38.212). According to some aspects, antenna ports that the base station indicates to the UE for the enhanced DMRS can be from enhanced antenna ports (e.g., antenna ports not indicated in, for example, Tables 7.3.1.1.2-8/9/10/11; Tables 7.3.1.1.2-12/13/14/15; Tables 7.3.1.1.2-16/17/18/19; and Tables 7.3.1.1.2-20/21/22/23 in TS 38.212). According to some aspects, antenna ports that the base station indicates to the UE for the enhanced DMRS can be from a combination of the legacy antenna ports and the enhanced antenna ports. In the implementation where the combination of the legacy antenna ports and the enhanced antenna ports is used, a further option can be that the indicated antenna ports are from the same Code Division Multiplexing (CDM) group.

As discussed in more detail below, according to some aspects and for the enhanced DMRS configuration Type 1, the legacy antenna ports can be ports 0/1/2/3/4/5/6/7. According to some aspects and for the enhanced DMRS configuration Type 1, the enhanced antenna ports can be antenna ports Aug. 9, 2010/11/12/13/14/15. According to some aspects and for the enhanced DMRS configuration Type 2, the legacy antenna ports can be antenna ports 0/1/2/3/4/5/6/7/8/9/10/11. According to some aspects and for the enhanced DMRS configuration Type 2, the enhanced antenna ports can be antenna ports Dec. 13, 2014/15/16/17/18/19/20/21/22/23.

Some aspects of this disclosure provide PUSCH antenna ports indication enhancement for enhanced DMRS with frequency domain orthogonal cover codes (FD-OCC) length 4. Some aspects are directed to DMRS configuration Type 1 and maximum 1 DMRS symbol. Some aspects are directed to DMRS configuration Type 1 and maximum 2 DMRS symbols.

According to some aspects, for the DMRS configuration Type 1 and maximum 1 DMRS symbols, the enhanced DMRS can support up to 8 antenna ports where the legacy DMRS supports up to 4 antenna ports. According to some aspects, for the DMRS configuration Type 1 and maximum 2 DMRS symbols, the enhanced DMRS supports up to 16 antenna ports where the legacy DMRS supports up to 8 antenna ports.

According to some aspects, for the DMRS configuration Type 2 and maximum 1 DMRS symbols, the enhanced DMRS supports up to 12 antenna ports where the legacy DMRS supports up to 6 antenna ports. According to some aspects, for the DMRS configuration Type 2 and maximum 2 DMRS symbols, the enhanced DMRS supports up to 24 antenna ports where the legacy DMRS supports up to 12 antenna ports.

Some aspects of this disclosure relate to a user equipment (UE). The UE includes a transceiver configured to wirelessly communicate with a base station and a processor communicatively coupled to the transceiver. The processor is configured to receive, using the transceiver, information associated with a configuration type for transmission of a demodulation reference signal (DMRS), a maximum number of symbols per a DMRS location, and a rank number for the transmission of the DMRS. The processor is further configured to determine a set of antenna ports for the transmission of the DMRS based on the information associated with the configuration type, the maximum number of symbols, and the rank number. The DMRS uses frequency division Orthogonal Cover Codes (FD-OCC) of length 4. The set of antenna ports includes one or more of a first subset of antenna ports, a second subset of antenna ports different from the first subset of antenna ports, or a combination of the first subset of antenna ports and a second subset of antenna ports.

In some aspects, the information associated with the configuration type includes configuration Type 1. The first subset of antenna ports can include one or more or a combination of antenna ports 0, 1, 2, 3, 4, 5, 6 and 7. The second subset of antenna ports can include one or more or a combination of antenna ports 8, 9, 10, 11, 12, 13, 14, and 15.

In some aspects, the information associated with the configuration type includes configuration Type 2. The first subset of antenna ports can include one or more or a combination of antenna ports 0, 1, 2, 3, 4, 5, 6, 7, 8, 9, 10, and 11. The second subset of antenna ports can include one or more or a combination of antenna ports 12, 13, 14, 15, 16, 17, 18, 19, 20, 21, 22, and 23.

In some aspects, the processor is configured to receive, using the transceiver, the information associated with the configuration type and the maximum number of symbols using radio resource control (RRC) configuration from the base station.

In some aspects, the processor is configured to receive, using the transceiver, the information associated with the rank number using a Downlink Control Information (DCI) message.

In some aspects, the processor is further configured to determine, from the set of antenna ports, one or more antenna ports and transmit, using the transceiver and to the base station, the DMRS using the determined one or more antenna ports. In some aspects, the processor is further configured to receive, using the transceiver and from the base station, an indication of the one or more antenna ports.

Some aspects of this disclosure relate to a method performed by a user equipment (UE) including receiving information associated with a configuration type for transmission of a demodulation reference signal (DMRS), a maximum number of symbols per a DMRS location, and a rank number for the transmission of the DMRS. The method also includes determining a set of antenna ports for the transmission of the DMRS based on the information associated with the configuration type, the maximum number of symbols, and the rank number. The DMRS uses frequency division Orthogonal Cover Codes (FD-OCC) of length 4. The set of antenna ports includes one or more of a first subset of antenna ports, a second subset of antenna ports different from the first subset of antenna ports, or a combination of the first subset of antenna ports and a second subset of antenna ports.

Some aspects of this disclosure relate to a non-transitory computer-readable medium storing instructions. When the instructions are executed by a processor of a user equipment (UE), the instructions cause the UE to perform operations including receiving information associated with a configuration type for transmission of a demodulation reference signal (DMRS), a maximum number of symbols per a DMRS location, and a rank number for the transmission of the DMRS. The operations also include determining a set of antenna ports for the transmission of the DMRS based on the information associated with the configuration type, the maximum number of symbols, and the rank number. The DMRS uses frequency division Orthogonal Cover Codes (FD-OCC) of length 4. The set of antenna ports includes one or more of a first subset of antenna ports, a second subset of antenna ports different from the first subset of antenna ports, or a combination of the first subset of antenna ports and a second subset of antenna ports.

This Summary is provided merely for purposes of illustrating some aspects to provide an understanding of the subject matter described herein. Accordingly, the above-described features are merely examples and should not be construed to narrow the scope or spirit of the subject matter in this disclosure. Other features, aspects, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system implementing mechanisms for indicating and using antenna ports for enhanced DMRS, according to some aspects of the disclosure.

FIG. 2 illustrates a block diagram of an example system of an electronic device implementing mechanisms for indicating and using antenna ports for enhanced DMRS, according to some aspects of the disclosure.

FIG. 3 illustrates an example method for a system (for example, a UE) performing mechanisms for indicating and using antenna ports for enhanced DMRS, according to some aspects of the disclosure.

FIG. 4 illustrates an example method for a system (for example, a base station) performing mechanisms for indicating and using antenna ports for enhanced DMRS, according to some aspects of the disclosure.

FIG. 5 is an example computer system for implementing some aspects or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some aspects of this disclosure relate to apparatuses and methods for implementing mechanisms for indicating and using antenna ports for enhanced Demodulation Reference Signal (DMRS). According to some aspects, by using the enhanced DMRS, the UE can be configured to use additional antenna ports in addition to the antenna ports indicated in TS 38.212. These additional antenna ports are also referred to as enhanced antenna ports in the disclosure. Additionally, or alternatively, the enhanced DMRS can increase the number of layers (layers also referred to herein as ranks) that the UE can use for transmitting DMRS. For example, the enhanced DMRS can increase the number of layers (e.g., the uplink layers—the layers corresponding to PUSCH) to eight layers. Therefore, the UE can be configured to use these additional antenna ports.

In some examples, the aspects of this disclosure can be performed by a network and/or a UE that operates according to 5^{th} generation (5G) wireless technology for digital cellular networks as defined by 3rd Generation Partnership Project (3GPP). Additionally, or alternatively, the aspects of this disclosure can be performed by a network and/or a UE that operates according to the Release 15 (Rel-15), Release 16 (Rel-16), Release 17 (Rel-17), Rel-17 new radio (NR), Rel-18, Rel-18 NR or others. However, the aspects of this disclosure are not limited to these examples, and one or more mechanisms of this disclosure can be implemented by other network(s) and/or UE(s) for indicating and using antenna ports for enhanced DMRS.

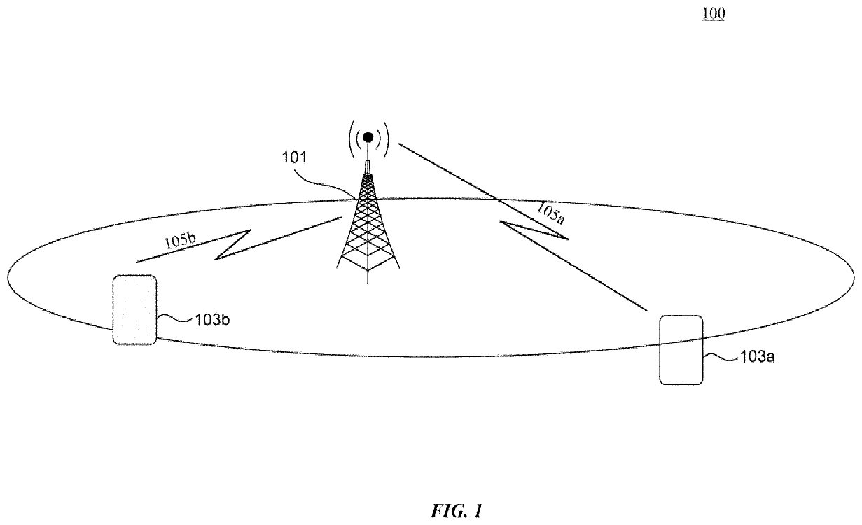

FIG. 1 illustrates an example system 100 implementing mechanisms for indicating and using antenna ports for enhanced DMRS, according to some aspects of the disclosure. Example system 100 is provided for the purpose of illustration only and does not limit the disclosed aspects.

System 100 may include, but is not limited to, a network node (for example, a base station such as eNBs, gNBs, and the like) 101 and electronic devices (for example, a UE) 103a and 103a. The electronic devices 103a and 103b (hereinafter referred to as UEs 103a and 103b, or UE 103 when referring to either UE 103a or UE 103b) can be configured to operate based on a wide variety of wireless communication techniques. These techniques can include, but are not limited to, techniques based on 3rd Generation Partnership Project (3GPP) standards. For example, the UE 103 can be configured to operate using Rel-15, Rel-16, Rel-17, Rel-17 NR, Rel-18, Rel-18 NR, or other. The UEs 103 can include, but is not limited to, wireless communication devices, smart phones, laptops, desktops, tablets, personal assistants, monitors, televisions, wearable devices, Internet of Things (IoTs), vehicle's communication devices, and the like. The network node 101 (herein referred to as a base station or a cell) can include one or more nodes configured to operate based on a wide variety of wireless communication techniques such as, but not limited to, techniques based on 3GPP standards. For example, the base station 101 can include one or more nodes configured to operate using Rel-15, Rel-16, Rel-17, Rel-17 NR, Rel-18, Rel-18 NR, or others.

According to some aspects, the UE 103a can be connected to and can communicate with the base station 101 using a carrier 105a and the UE 103b can be connected to and can communicate with the base station 101 using a carrier 105b. According to some aspects, each of the carriers 105a and 105b (also referred to as the carrier 105 when referring to either carrier 105a or carrier 105b or both) can include one carrier. Additionally, or alternatively, the carrier 105 can include two or more component carriers (CC). In other words, the UE 103 can implement carrier aggregation (CA). For example, the UE 103 can use multiple carriers for communication with the base station 101.

According to some aspects, base station 101 and UE 103 are configured to implement mechanisms for indicating and using antenna ports for enhanced DMRS. According to some aspects, by using the enhanced DMRS, the UE 103 can be configured to use additional antenna ports in addition to the antenna ports indicated in TS 38.212. These additional antenna ports are also referred to as enhanced antenna ports in the disclosure. Additionally, or alternatively, the enhanced DMRS can increase the number of layers that the UE 103 can use for transmitting DMRS. Therefore, the UE can be configured to use these additional antenna ports.

According to some aspects, the UE 103 can transmit data on PUSCH (also referred to herein as PUSCH transmission) in combination with transmitting DMRS. The UE 103 can use the same precoding for PUSCH and DMRS and the UE can transmit the PUSCH and DMRS using the same antenna ports. The UE 103 can include a Multiple-Input Multiple-Output (MIMO) antenna with a plurality of ports. The base station 101 can know the sequence used for the transmission of the DMRS. After receiving the DMRS, the base station 101 can compare the received DMRS with the transmitted DMRS to determine the channel quality of the uplink channel. Additionally, or alternatively, the base station 101 can use the received DMRS to determine (e.g., produce) channel estimates for demodulation of the PUSCH. The base station 101 can use the received DMRS for decoding the PUSCH.

The UE 103 can transmit the DMRS within a set of Resource Blocks allocated to the PUSCH. According to some aspects, the DMRS for PUSCH can include a variety of configurations to support different requirements for single user and multi user MIMO. The configurations for the DMRS can include, but is not limited to, configuration Type 1 or Type 2 and single or double symbol. However, the aspects of this disclosure are not limited to these examples, and the configurations for the DMRS can include other parameters.

In some aspects, the configuration Type can impact the frequency domain resources used by the DMRS. In a non-limiting example, for the configuration Type 1, one subcarrier for every n^{th} subcarrier can be used for the DMRS. In a non-limiting example, for the configuration Type 2, two subcarriers for every m^{th} subcarrier can be used for the DMRS. Here n and m can integer numbers greater than one. However, the aspects of this disclosure are not limited to these examples, and other examples of configuration Type 1 and Type 2 can be used for the DMRS. For single and double symbol (also referred herein as maximum length), a single symbol or a double symbol can be used for the DMRS, respectively.

According to some aspects, the UE 103 can determine the antenna ports to use for the transmission of the enhanced DMRS based, at least, on the configuration Type, the maximum length, and/or a number of layers (also referred to herein as rank number). The layer indicates an independent data stream sent by the UE 103 (having, for example, a MIMO antenna) on a spatial channel. Different number of layers can indicate different independent data streams sent on different spatial channels. According to some aspects, the UE can have a precoder for each layer, and the base station 101 can signal to the UE 103 what weighting factor the UE 103 to use for each layer. The base station 101 can indicate to the UE 103 how many layers to use for the PUSCH and/or DMRS transmission. The base station 101 can also indicate to the UE 103 which precoding and/or which beamforming to apply for each layer for the PUSCH and/or DMRS transmission.

According to some aspects, the base station 101 can signal the configuration Type, the maximum length, and/or the number of layers to the UE 103. In a non-limiting example, the base station can transmit information associated with the configuration Type and the maximum length to the UE 103 using radio resource control (RRC) signaling. For example, the base station 101 can provide the RRC configuration to the UE 103 at an initial establishment of the RRC connection between the UE 103 and the base station 101. The RRC configuration can indicate, to the UE 103, the configuration Type and the maximum length that the UE 103 would use for the enhanced DMRS transmission. However, the aspects of this disclosure can include other methods for the base station to configure (and/or to signal to UE 103) the configuration Type and the maximum length at the UE 103.

In a non-limiting example, the base station 101 can transmit information associated with the number of layers to the UE 103 using a Downlink Control Information (DCI) message. For example, the base station 101 can use DCI Format 0_0, DCI Format 0_1, and/or DCI Format 0_2 to transmit information associated with the number of layers to the UE 103. The base station 101 can use other DCI message to transmit information associated with the number of layers to the UE 103. Additionally, or alternatively, the base station 101 can use other messages/signaling to transmit information associated with the number of layers to the UE 103.

The UE 103 can determine the antenna ports to use for the transmission of the enhanced DMRS based, at least, on the configuration Type, the maximum length, and the number of layers. According to some aspects, the antenna ports that the UE 103 uses for the enhanced DMRS can be from the legacy antenna ports (e.g., antenna ports indicated in TS 38.212—for example, Tables 7.3.1.1.2-8/9/10/11; Tables 7.3.1.1.2-12/13/14/15; Tables 7.3.1.1.2-16/17/18/19; and Tables 7.3.1.1.2-20/21/22/23 in TS 38.212). According to some aspects, the antenna ports that the UE 103 uses for the enhanced DMRS can be from enhanced antenna ports (e.g., antenna ports not indicated in, for example, Tables 7.3.1.1.2-8/9/10/11; Tables 7.3.1.1.2-12/13/14/15; Tables 7.3.1.1.2-16/17/18/19; and Tables 7.3.1.1.2-20/21/22/23 in TS 38.212). According to some aspects, the antenna ports that the UE 103 uses for the enhanced DMRS can be from a combination of the legacy antenna ports and the enhanced antenna ports. In the implementation where the combination of the legacy antenna ports and the enhanced antenna ports is used, a further option can be that the indicated antenna ports are from the same CDM group.

According to some aspects and for the enhanced DMRS configuration Type 1, the legacy antenna ports can be antenna ports 0/1/2/3/4/5/6/7. According to some aspects and for the enhanced DMRS configuration Type 1, the enhanced antenna ports can be antenna ports Aug. 9, 2010/11/12/13/14/15. According to some aspects and for the enhanced DMRS configuration Type 2, the legacy antenna ports can be antenna ports 0/1/2/3/4/5/6/7/8/9/10/11. According to some aspects and for the enhanced DMRS configuration Type 2, the enhanced antenna ports can be antenna ports Dec. 13, 2014/15/16/17/18/19/20/21/22/23.

According to some aspects, for the DMRS with configuration Type 1 and the maximum length of 1 symbol per DMRS location, legacy antenna ports 0, 1 belong to CDM group 0, legacy antenna ports 2, 3 belong to CDM group 1, enhanced antenna ports 8, 9 belong to CDM group 0, and enhanced antenna ports 10, 11 belong to CDM group 1.

According to some aspects, for the DMRS with configuration Type 1 and the maximum length of 2 symbol per DMRS location, legacy antenna ports 4, 5 belong to CDM group 0, legacy antenna ports 6, 7 belong to CDM group 1, enhanced antenna ports 12, 13 belong to CDM group 0, and enhanced antenna ports 14, 15 belong to CDM group 1.

According to some aspects, for the DMRS with configuration Type 2 and the maximum length of 1 symbol per DMRS location, legacy antenna ports 0, 1 belong to CDM group 0, legacy antenna ports 2, 3 belong to CDM group 1, legacy antenna ports 4, 5 belong to CDM group 2, enhanced antenna ports 12, 13 belong to CDM group 0, enhanced antenna ports 14, 15 belong to CDM group 1, and enhanced antenna ports 16, 17 belong to CDM group 2.

According to some aspects, for the DMRS with configuration Type 2 and the maximum length of 2 symbol per DMRS location, legacy antenna ports 6, 7 belong to CDM group 0, legacy antenna ports 8, 9 belong to CDM group 1, legacy antenna ports 10, 11 belong to CDM group 2, enhanced antenna ports 18, 19 belong to CDM group 0, enhanced antenna ports 20, 21 belong to CDM group 1, and enhanced antenna ports 22, 23 belong to CDM group 2.

According to some aspects, for enhanced DMRS with configuration Type 1 (dmrs-Type=1), the maximum length of 1 symbol per DMRS location (maxLength=1), and for rank 1, in addition to the existing antenna port(s) in Table 7.3.1.1.2-8 of TS38.212, the UE 103 can use one or more entries from Table 1 below. In other words, new entries of Table 1 below can be added to the existing Table 7.3.1.1.2-8 of TS38.212.

TABLE 1

| Number of DMRS CDM group(s) without data | DMRS port(s) |
|---|---|
| 1 | 8 |
| 1 | 9 |
| 2 | 8 |
| 2 | 9 |
| 2 | 10 |
| 2 | 11 |

In other words, for enhanced DMRS with configuration Type 1 (dmrs-Type=1), the maximum length of 1 symbol per DMRS location (maxLength=1), and for rank 1, the UE 103 can use the enhanced antenna ports 8, 9, 10, and 11 in addition to, or instead of, the legacy antenna ports 0, 1, 2, and 3. In some examples, the enhanced antenna ports are the legacy antenna ports increased by number 8. In other words, the enhanced antenna port(s) in each row are the legacy antenna port(s) in a corresponding row of the legacy table that are increased by number 8.

According to some aspects, the enhanced antenna ports 8 and 9 are part of CDM group 0 for configuration Type 1 (dmrs-Type=1) and the maximum length of 1 symbol per DMRS location (maxLength=1). The enhanced antenna ports 10 and 11 are part of CDM group 1 for configuration Type 1 (dmrs-Type=1) and the maximum length of 1 symbol per DMRS location (maxLength=1). According to some aspects, the number of DMRS CDM group(s) without data in Table 1 (and also Tables 2-13 below) can indicate if one CDM group is used or two CDM groups are used. For example, when the number of DMRS CDM group(s) without data is 1, CDM group 0 or CDM group 1 is used. When the number of DMRS CDM group(s) without data is 2, both CDM group 0 and CDM group 1 are used. According to some aspects, the antenna ports that share the same Resource Elements can be differentiated using OCC that can allow the CDM.

In a non-limiting example of two-user MIMO (an example of a multi-user MIMO), the base station 101 can indicate to a first UE (e.g., UE 103a) to use antenna port 8 (e.g., the first row of Table 1) and the base station 101 can indicate to a second UE (e.g., UE 103b) to use antenna port 9 (e.g., the second row of Table 1).

According to some aspects, for enhanced DMRS with configuration Type 1 (dmrs-Type=1), the maximum length of 1 symbol per DMRS location (maxLength=1), and for rank 2, in addition to the existing antenna port(s) in Table 7.3.1.1.2-9 of TS38.212, the UE 103 can use one or more entries from Table 2 below. In other words, new entries of Table 2 below can be added to the existing Table 7.3.1.1.2-9 of TS38.212.

TABLE 2

| Number of DMRS CDM | | |
|---|---|---|
| group(s) without data | DMRS port(s) | Note |
| 1 | 8, 9 | adding 8 to |
| 2 | 8, 9 | existing entries |
| 2 | 10, 11 | |
| 2 | 8, 10 | |
| 1 | 0, 8 | mixture of legacy |
| 2 | 0, 8 | and enhanced |
| 2 | 0, 10 | ports |
| 2 | 2, 8 | |

For example, for enhanced DMRS with configuration Type 1 (dmrs-Type=1), the maximum length of 1 symbol per DMRS location (maxLength=1), and for rank 2, the UE 103 can use the enhanced antenna ports 8, 9; 8, 9; 10, 11; 8, 10; 0, 8; 0, 8; 0, 10; and 2, 8 in addition to, or instead of, the legacy antenna ports 0, 1; 0, 1; 2, 3; and 0, 2. In some examples, the enhanced antenna ports in the first four rows of Table 2 are the legacy antenna ports increased by number 8. In other words, the enhanced antenna port(s) in each row of the first four rows of Table 2 are the legacy antenna port(s) in a corresponding row of the legacy table that are increased by number 8.

In some examples, the antenna ports in the second four rows of Table 2 are a combination of the legacy antenna ports and the enhanced antenna ports. Table 2 is not limited to the combinations provided, and can include other enhanced antenna port numbers and/or other combinations of the legacy antenna ports and the enhanced antenna ports.

When the combination of the legacy antenna ports and the enhanced antenna ports are used, the legacy antenna ports and the enhanced antenna ports can be selected from one CDM group. Alternatively, the legacy antenna ports and the enhanced antenna ports can be selected from different CDM groups. For example, the legacy antenna ports can be from a first CDM group and the enhanced antenna ports can be from a second CDM group different from the first CDM group.

According to some aspects, for enhanced DMRS with configuration Type 1 (dmrs-Type=1), the maximum length of 1 symbol per DMRS location (maxLength=1), and for rank 3, in addition to the existing antenna port(s) in Table 7.3.1.1.2-10 of TS38.212, the UE 103 can use one or more entries from Table 3 below. In other words, new entries of Table 3 below can be added to the existing Table 7.3.1.1.2-10 of TS38.212.

TABLE 3

| Number of DMRS CDM | | |
|---|---|---|
| group(s) without data | DMRS port(s) | Note |
| 2 | 8, 9, 10 | adding 8 to |
| | | existing entries |
| 2 | 0, 1, 8 | mixture of legacy |
| 2 | 0, 8, 9 | and enhanced |
| 2 | 0, 1, 10 | ports |

For example, for enhanced DMRS with configuration Type 1 (dmrs-Type=1), the maximum length of 1 symbol per DMRS location (maxLength=1), and for rank 3, the UE 103 can use the enhanced antenna ports 8, 9, 10; 0, 1, 8; 0, 8, 9; and 0, 1, 10; in addition to, or instead of, the legacy antenna ports 0, 1, 2. In some examples, the enhanced antenna ports in the first row of Table 3 are the legacy antenna ports increased by number 8. In other words, the enhanced antenna port(s) in each row of the first row of Table 3 are the legacy antenna port(s) in a corresponding row of the legacy table that are increased by number 8.

In some examples, the antenna ports in the last third rows of Table 3 are a combination of the legacy antenna ports and the enhanced antenna ports. Table 3 is not limited to the combinations provided, and can include other enhanced antenna port numbers and/or other combinations of the legacy antenna ports and the enhanced antenna ports.

When the combination of the legacy antenna ports and the enhanced antenna ports are used, the legacy antenna ports and the enhanced antenna ports can be selected from on CDM group. Alternatively, the legacy antenna ports and the enhanced antenna ports can be selected from different CDM groups. For example, the legacy antenna ports can be from a first CDM group and the enhanced antenna ports can be from a second CDM group different from the first CDM group.

According to some aspects, for enhanced DMRS with configuration Type 1 (dmrs-Type=1), the maximum length of 1 symbol per DMRS location (maxLength=1), and for rank 4, in addition to the existing antenna port(s) in Table 7.3.1.1.2-11 of TS38.212, the UE 103 can use one or more entries from Table 4 below. In other words, new entries of Table 4 below can be added to the existing Table 7.3.1.1.2-11 of TS38.212.

TABLE 4

| Number of DMRS CDM | | |
|---|---|---|
| group(s) without data | DMRS port(s) | Note |
| 2 | 8, 9, 10, 11 | adding 8 to |
| | | existing entries |
| 2 | 0, 1, 8, 9 | mixture of legacy |
| 2 | 2, 3, 8, 9 | and enhanced |
| 2 | 0, 1, 10, 11 | ports |

For example, for enhanced DMRS with configuration Type 1 (dmrs-Type=1), the maximum length of 1 symbol per DMRS location (maxLength=1), and for rank 4, the UE 103 can use the enhanced antenna ports 8, 9, 10, 11; 0, 1, 8, 9; 2, 3, 8, 9; and 0, 1, 10, 11 in addition to, or instead of, the legacy antenna ports 0, 1, 2, 3. In some examples, the enhanced antenna ports in the first row of Table 4 are the legacy antenna ports increased by number 8. In other words, the enhanced antenna port(s) in each row of the first row of Table 4 are the legacy antenna port(s) in a corresponding row of the legacy table that are increased by number 8.

In some examples, the antenna ports in the last third rows of Table 4 are a combination of the legacy antenna ports and the enhanced antenna ports. Table 4 is not limited to the combinations provided, and can include other enhanced antenna port numbers and/or other combinations of the legacy antenna ports and the enhanced antenna ports.

When the combination of the legacy antenna ports and the enhanced antenna ports are used, the legacy antenna ports and the enhanced antenna ports can be selected from one CDM group. Alternatively, the legacy antenna ports and the enhanced antenna ports can be selected from different CDM groups. For example, the legacy antenna ports can be from a first CDM group and the enhanced antenna ports can be from a second CDM group different from the first CDM group.

According to some aspects, for enhanced DMRS with configuration Type 1 (dmrs-Type=1), the maximum length of 1 symbol per DMRS location (maxLength=1), and for ranks 5, 6, 7, and 8, the UE 103 can use one or more entries from Table 5 below.

TABLE 5

| Number of DMRS CDM | | |
|---|---|---|
| group(s) without data | DMRS port(s) | Note |
| 2 | 0, 1, 2, 3, 8 | Rank 5 |
| 2 | 0, 8, 9, 10, 11 | |
| 2 | 0, 1, 2, 8, 9 | |
| 2 | 0, 1, 8, 9, 10 | |
| 2 | 0, 1, 2, 3, 8, 9 | Rank 6 |
| 2 | 0, 1, 8, 9, 10, 11 | |
| 2 | 0, 1, 2, 3, 8, 9, 10 | Rank 7 |
| 2 | 0, 1, 2, 8, 9, 10, 11 | |
| 2 | 0, 1, 2, 3, 8, 9, 10, 11 | Rank 8 |

According to some aspects, the antenna ports in Table 5 are combinations of the legacy antenna ports and the enhanced antenna ports. The rank 5/6/7/8 are not supported by purely the legacy DMRS with dmrs-Type=1, maxLength=1. Table 5 is not limited to the combinations provided, and can include other enhanced antenna port numbers and/or other combinations of the legacy ports and the enhanced ports.

According to some aspects, for enhanced DMRS with configuration Type 1 (dmrs-Type=1), the maximum length of 2 symbols per DMRS location (maxLength=2), and for rank 1, in addition to the existing antenna port(s) in Table 7.3.1.1.2-12 of TS38.212, the UE 103 can use one or more entries from Table 6 below. In other words, new entries of Table 6 below can be added to the existing Table 7.3.1.1.2-12 of TS38.212.

TABLE 6

| Number of DMRS CDM | | Number of front- |
|---|---|---|
| group(s) without data | DMRS port(s) | load symbols |
| 2 | 8 | 2 |
| 2 | 9 | 2 |
| 2 | 10 | 2 |
| 2 | 11 | 2 |
| 2 | 12 | 2 |
| 2 | 13 | 2 |
| 2 | 14 | 2 |
| 2 | 15 | 2 |

In other words, for enhanced DMRS with configuration Type 1 (dmrs-Type=1), the maximum length of 2 symbols per DMRS location (maxLength=1), and for rank 1, the UE 103 can use the enhanced antenna ports 8, 9, 10, 11, 12, 13, 14, and 15 in addition to, or instead of, the legacy antenna ports 0, 1, 2, 3, 4, 5, 6, and 7. In some examples, the enhanced antenna ports are the legacy antenna ports increased by number 8. In other words, the enhanced antenna port(s) in each row are the legacy antenna port(s) in a corresponding row of the legacy table that are increased by number 8. However, Table 5 is not limited to these combinations and other combinations can also be used.

According to some aspects, the number of front-load symbols in Table 6 illustrates the actual number of symbol(s) used for the enhanced DMRS transmission. Although the maximum length of 2 symbols per DMRS location (maxLength=2) is used, the actual number of symbol(s) used for the enhanced DMRS transmission can be 1 symbol or 2 symbols. Table 6 illustrates the antenna ports for the number of front-load symbols being 2. For the number of front-load symbols being 1, Table 1 discussed above can be used.

According to some aspects, the enhanced antenna ports 8 and 9 are part of CDM group 0 for configuration Type 1 (dmrs-Type=1) and the maximum length of 2 symbols per DMRS location (maxLength=2). The enhanced antenna ports 10 and 11 are part of CDM group 1 for configuration Type 1 (dmrs-Type=1) and the maximum length of 2 symbols per DMRS location (maxLength=2). The enhanced antenna ports 12 and 13 are part of CDM group 0 for configuration Type 1 (dmrs-Type=1) and the maximum length of 2 symbols per DMRS location (maxLength=2). The enhanced antenna ports 14 and 15 are part of CDM group 1 for configuration Type 1 (dmrs-Type=1) and the maximum length of 2 symbols per DMRS location (maxLength=2).

According to some aspects, for enhanced DMRS with configuration Type 1 (dmrs-Type=1), the maximum length of 2 symbols per DMRS location (maxLength=2), and for rank 2, in addition to the existing antenna port(s) in Table 7.3.1.1.2-13 of TS38.212, the UE 103 can use one or more entries from Table 7 below. In other words, new entries of Table 7 below can be added to the existing Table 7.3.1.1.2-13 of TS38.212.

TABLE 7

| Number of DMRS | | Number of | |
|---|---|---|---|
| CDM group(s) | | front-load | |
| without data | DMRS port(s) | symbols | Note |
| 2 | 8, 9 | 2 | adding 8 to |
| 2 | 10, 11 | 2 | existing |
| 2 | 12, 13 | 2 | entries |
| 2 | 14, 15 | 2 | |
| 2 | 8, 12 | 2 | |
| 2 | 10, 14 | 2 | |
| 2 | 0, 8 | 2 | mixture of |
| 2 | 2, 10 | 2 | legacy and |
| 2 | 4, 12 | 2 | enhanced |
| 2 | 6, 14 | 2 | ports |

For example, for enhanced DMRS with configuration Type 1 (dmrs-Type=1), the maximum length of 2 symbols per DMRS location (maxLength=1), and for rank 2, the UE 103 can use the enhanced antenna ports 8, 9; 10, 11; 12, 13; 14, 15; 8, 12; and 10, 14 in addition to, or instead of, the legacy antenna ports 0, 1; 2, 3; 4, 5; 6, 7; 0, 4; and 2, 6. In some examples, the enhanced antenna ports in the first six rows of Table 7 are the legacy antenna ports increased by number 8. In other words, the enhanced antenna port(s) in each row of the first six rows of Table 7 are the legacy antenna port(s) in a corresponding row of the legacy table that are increased by number 8.

In some examples, the antenna ports in the last four rows of Table 7 are a combination of the legacy antenna ports and the enhanced antenna ports. However, Table 7 is not limited to the combinations provided, and can include other combinations of the legacy antenna ports and the enhanced antenna ports.

When the combination of the legacy antenna ports and the enhanced antenna ports are used, the legacy antenna ports and the enhanced antenna ports can be selected from one CDM group. Alternatively, the legacy antenna ports and the enhanced antenna ports can be selected from different CDM groups. For example, the legacy antenna ports can be from a first CDM group and the enhanced antenna ports can be from a second CDM group different from the first CDM group.

According to some aspects, the number of front-load symbols in Table 7 illustrates the actual number of symbol(s) used for the enhanced DMRS transmission. Table 7 illustrates the antenna ports for the number of front-load symbols being 2. For the number of front-load symbols being 1, Table 2 discussed above can be used.

According to some aspects, for enhanced DMRS with configuration Type 1 (dmrs-Type=1), the maximum length of 2 symbols per DMRS location (maxLength=2), and for rank 3, in addition to the existing antenna port(s) in Table 7.3.1.1.2-14 of TS38.212, the UE 103 can use one or more entries from Table 8 below. In other words, new entries of Table 8 below can be added to the existing Table 7.3.1.1.2-14 of TS38.212.

TABLE 8

| Number of DMRS | | Number of | |
|---|---|---|---|
| CDM group(s) | | front-load | |
| without data | DMRS port(s) | symbols | Note |
| 2 | 8, 9, 12 | 2 | adding 8 to |
| | | | existing |
| 2 | 10, 11, 14 | 2 | entries |
| 2 | 0, 1, 8 | 2 | mixture of |
| 2 | 2, 3, 10 | 2 | legacy and |
| 2 | 4, 5, 12 | 2 | enhanced |
| 2 | 6, 7, 14 | 2 | ports |

For example, for enhanced DMRS with configuration Type 1 (dmrs-Type=1), the maximum length of 2 symbols per DMRS location (maxLength=2), and for rank 3, the UE 103 can use the enhanced antenna ports 8, 9, 12; and 10, 11, 14 in addition to, or instead of, the legacy antenna ports 0, 1, 4; and 2, 3, 6. In some examples, the enhanced antenna ports in the first two rows of Table 8 are the legacy antenna ports increased by number 8. In other words, the enhanced antenna port(s) in each row of the first two rows of Table 8 are the legacy antenna port(s) in a corresponding row of the legacy table that are increased by number 8.

In some examples, the antenna ports in the last four rows of Table 8 are a combination of the legacy antenna ports and the enhanced antenna ports. However, Table 8 is not limited to the combinations provided, and can include other enhanced antenna port numbers and/or other combinations of the legacy antenna ports and the enhanced antenna ports.

When the combination of the legacy antenna ports and the enhanced antenna ports are used, the legacy antenna ports and the enhanced antenna ports can be selected from one CDM group. Alternatively, the legacy antenna ports and the enhanced antenna ports can be selected from different CDM groups. For example, the legacy antenna ports can be from a first CDM group and the enhanced antenna ports can be from a second CDM group different from the first CDM group.

According to some aspects, the number of front-load symbols in Table 8 illustrates the actual number of symbol(s) used for the enhanced DMRS transmission. Table 8 illustrates the antenna ports for the number of front-load symbols being 2. For the number of front-load symbols being 1, Table 3 discussed above can be used.

According to some aspects, for enhanced DMRS with configuration Type 1 (dmrs-Type=1), the maximum length of 2 symbols per DMRS location (maxLength=2), and for rank 4, in addition to the existing antenna port(s) in Table 7.3.1.1.2-15 of TS38.212, the UE 103 can use one or more entries from Table 9 below. In other words, new entries of Table 8 below can be added to the existing Table 7.3.1.1.2-15 of TS38.212.

TABLE 9

| Number of DMRS | | Number of | |
|---|---|---|---|
| CDM group(s) | | front-load | |
| without data | DMRS port(s) | symbols | Note |
| 2 | 8, 9, 12, 13 | 2 | adding 8 to |
| 2 | 10, 11, 14, 15 | 2 | existing |
| 2 | 8, 10, 12, 14 | 2 | entries |
| 2 | 0, 1, 8, 9 | 2 | mixture of |
| 2 | 2, 3, 10, 11 | 2 | legacy and |
| 2 | 4, 5, 12, 13 | 2 | enhanced |
| 2 | 6, 7, 14, 15 | 2 | ports |

For example, for enhanced DMRS with configuration Type 1 (dmrs-Type=1), the maximum length of 2 symbols per DMRS location (maxLength=1), and for rank 4, the UE 103 can use the enhanced antenna ports 8, 9, 12, 13; 10, 11, 14, 15; and 8, 10, 12, 14 in addition to, or instead of, the legacy antenna ports 0, 1, 4, 5; 2, 3, 6, 7; and 0, 2, 4, 6. In some examples, the enhanced antenna ports in the first three rows of Table 9 are the legacy antenna ports increased by number 8. In other words, the enhanced antenna port(s) in each row of the first three rows of Table 9 are the legacy antenna port(s) in a corresponding row of the legacy table that are increased by number 8.

In some examples, the antenna ports in the last four rows of Table 9 are a combination of the legacy antenna ports and the enhanced antenna ports. However, Table 9 is not limited to the combinations provided, and can include other enhanced antenna port numbers and/or other combinations of the legacy antenna ports and the enhanced antenna ports.

When the combination of the legacy antenna ports and the enhanced antenna ports are used, the legacy antenna ports and the enhanced antenna ports can be selected from on CDM group. Alternatively, the legacy antenna ports and the enhanced antenna ports can be selected from different CDM groups. For example, the legacy antenna ports can be from a first CDM group and the enhanced antenna ports can be from a second CDM group different from the first CDM group.

According to some aspects, the number of front-load symbols in Table 9 illustrates the actual number of symbol(s) used for the enhanced DMRS transmission. Table 9 illustrates the antenna ports for the number of front-load symbols being 2. For the number of front-load symbols being 1, Table 4 discussed above can be used.

According to some aspects, for enhanced DMRS with configuration Type 1 (dmrs-Type=1), the maximum length of 2 symbol per DMRS location (maxLength=1), and for ranks 5, 6, 7, and 8, the UE 103 can use one or more entries from Tables 10, 11, 12, and 13 below, respectively.

Table 10 (for rank 5)

| Number of DMRS | | Number of | |
|---|---|---|---|
| CDM group(s) | | front-load | |
| without data | DMRS port(s) | symbols | Note |
| 2 | 0, 1, 2, 3, 4 | 2 | all legacy |
| | | | ports |
| 2 | 8, 9, 10, 11, 12 | 2 | all enhanced |
| | | | ports |
| 2 | 0, 1, 4, 5, 8 | 2 | mixture of |
| 2 | 0, 8, 9, 12, 13 | 2 | legacy and |
| 2 | 0, 1, 2, 3, 8 | 2 | enhanced |
| 2 | 0, 8, 9, 10, 11 | 2 | ports |

Table 11 (for rank 6)

| | | Number | |
|---|---|---|---|
| Number of DMRS | | of front- | |
| CDM group(s) | | load | |
| without data | DMRS port(s) | symbols | Note |
| 2 | 0, 1, 2, 3, 4, 5 | 2 | all legacy |
| 2 | 0, 1, 2, 3, 4, 6 | 2 | ports |
| 2 | 8, 9, 10, 11, 12, 13 | 2 | all enhanced |
| 2 | 8, 9, 10, 11, 12, 14 | 2 | ports |
| 2 | 0, 1, 4, 5, 8, 12 | 2 | mixture of |
| 2 | 0, 4, 8, 9, 12, 13 | 2 | legacy and |
| 2 | 0, 1, 2, 3, 8, 9 | 2 | enhanced |
| 2 | 0, 1, 8, 9, 10, 11 | 2 | ports |

Table 12 (for rank 7)

| | | Number | |
|---|---|---|---|
| | | of | |
| Number of DMRS | | front- | |
| CDM group(s) | | load | |
| without data | DMRS port(s) | symbols | Note |
| 2 | 0, 1, 2, 3, 4, 5, 6 | 2 | all legacy |
| | | | ports |
| 2 | 8, 9, 10, 11, 12, 13, | 2 | all enhanced |
| | 14 | | ports |
| 2 | 0, 1, 4, 5, 8, 9, 12 | 2 | mixture of |
| 2 | 0, 1, 4, 8, 9, 12, 13 | 2 | legacy and |
| 2 | 0, 1, 2, 3, 8, 9, 10 | 2 | enhanced |
| 2 | 0, 1, 2, 8, 9, 10, 11 | 2 | ports |

Table 13 (for rank 8)

| | | Number | |
|---|---|---|---|
| | | of | |
| Number of DMRS | | front- | |
| CDM group(s) | | load | |
| without data | DMRS port(s) | symbols | Note |
| 2 | 0, 1, 2, 3, 4, 5, 6, 7 | 2 | all legacy |
| | | | ports |
| 2 | 8, 9, 10, 11, 12, 13, | 2 | all enhanced |
| | 14, 15 | | ports |
| 2 | 0, 1, 4, 5, 8, 9, 12, 13 | 2 | mixture of |
| 2 | 0, 1, 2, 3, 8, 9, 10, 11 | 2 | legacy and |
| 2 | 2, 3, 6, 7, 10, 11, 14, 15 | 2 | enhanced |
| 2 | 4, 5, 6, 7, 12, 13, 14, 15 | 2 | ports |

According to some aspects, the antenna ports in Tables 10-13 can be (1) all legacy antenna ports, (2) all enhanced antenna ports, or (3) combinations of the legacy antenna ports and the enhanced antenna ports. The ranks 5/6/7/8 are not supported by the legacy DMRS with dmrs-Type=1, maxLength=2. Table 10-13 is not limited to the antenna ports and the combinations provided, and can include other enhanced antenna port numbers and/or other combinations of the legacy ports and the enhanced ports.

According to some aspects, the number of front-load symbols in Tables 10-13 illustrates the actual number of symbol(s) used for the enhanced DMRS transmission. Tables 10-13 illustrate the antenna ports for the number of front-load symbols being 2. For the number of front-load symbols being 1, Table 5 discussed above can be used for respective rank number.

Although some aspects of this disclosure are discussed with respect to enhanced DMRS configuration Type 1, the aspects of this disclosure are not limited to these examples and can be applied to, for example, enhanced DMRS configuration Type 2.

According to some aspects, the enhanced DMRS can use frequency division Orthogonal Cover Codes (FD-OCC) of length 4. For example, the enhanced DMRS can use the FD-OCCs with a FD-OCC index 0, a FD-OCC index 1, a FD-OCC index 2, or a FD-OCC index 3. According to some aspects, a Walsh matrix (e.g., a Hadamard code) and/or cyclic shifts can be defined for the FD-OCC indexes 0-3 for the enhanced DMRS. According to some aspects, the enhanced DMRS using the FD-OCC of length 4 can double the amount of DMRS that system 100 can support. Additionally, or alternatively, the enhanced DMRS using the FD-OCC of length 4 can double the number of layers that system 100 can support. For example, the enhanced DMRS can increase the number of layers that the UE can use for transmitting DMRS. For example, the enhanced DMRS can increase the number of layers (e.g., the uplink layers) to eight layers.

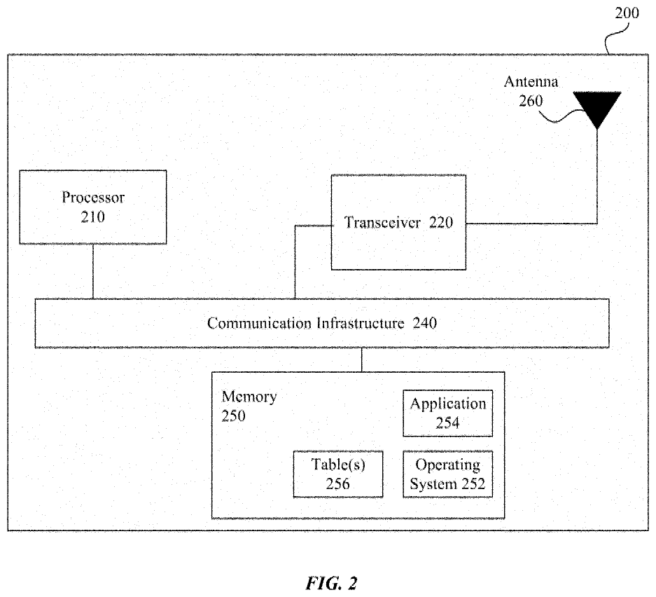

FIG. 2 illustrates a block diagram of an example system 200 of an electronic device implementing mechanisms for indicating and using antenna ports for enhanced DMRS, according to some aspects of the disclosure. System 200 may be any of the electronic devices (e.g., base station 101, UE 103) of system 100. System 200 includes a processor 210, one or more transceivers 220, a communication infrastructure 240, a memory 250, operating system 252, application 254, one or more tables 256, and/or one or more antennas 260. Illustrated systems are provided as exemplary parts of system 200, and system 200 can include other circuit(s) and subsystem(s). Also, although the systems of system 200 are illustrated as separate components, the aspects of this disclosure can include any combination of these, less, or more components. Also, system 200 of the aspects of this disclosure can include any number of processors, transceivers, communication infrastructures, memories, operating systems, applications, and antennas.

The memory 250 may include random access memory (RAM) and/or cache, and may include control logic (e.g., computer software) and/or data. The memory 250 may include other storage devices or memory such as, but not limited to, a hard disk drive and/or a removable storage device/unit. According to some examples, the operating system 252 can be stored in memory 250. The operating system 252 can manage transfer of data between the memory 250, one or more applications 254, the processor 210, and/or one or more transceivers 220. In some examples, the operating system 252 maintains one or more network protocol stacks (e.g., Internet protocol stack, cellular protocol stack, and the like) that can include a number of logical layers. At corresponding layers of the protocol stack, the operating system 252 includes control mechanism and data structures to perform the functions associated with that layer.

According to some examples, the application 254 can be stored in the memory 250. The application 254 can include applications (e.g., user applications) used by wireless system 200 and/or a user of wireless system 200. The applications in the application 254 can include applications such as, but not limited to, radio streaming, video streaming, remote control, and/or other user applications.

According to some aspects, the memory 250 can include one or more tables 256. The one or more tables 256 can include one or more of Tables 1-13 for indicating and using antenna ports for enhanced DMRS, as described herein. The one or more tables 256 can include other information used for indicating and using antenna ports for enhanced DMRS.

System 200 can also include the communication infrastructure 240. The communication infrastructure 240 provides communication between, for example, the processor 210, the one or more transceivers 220, and the memory 250. In some implementations, the communication infrastructure 240 may be a bus. The processor 210 together with instructions stored in memory 250 performs operations enabling system 200 of system 100 to implement mechanisms for indicating and using antenna ports for enhanced DMRS, as described herein.

The one or more transceivers 220 transmit and receive communications signals that support the operations of system 200 including, but not limited to, mechanisms for indicating and using antenna ports for enhanced DMRS, according to some aspects, and may be coupled to the one or more antennas 260. The one or more antennas 260 may include one or more antennas that may be the same or different types. The one or more antennas 260 may include one or more MIMO antenna(s) having one or more antenna ports. According to some aspects, each antenna port of the one or more antennas 260 can carry its resource grid and one or more reference signals. The antenna ports of the one or more antennas 260 can be indicated using port numbers. Different antenna ports can be assigned to different channels and/or signals. In some examples, antenna ports starting with 0 can be assigned to enhanced DMRS/DMRS/PUSCH.

The one or more transceivers 220 allow system 200 to communicate with other devices that may be wired and/or wireless. In some examples, the one or more transceivers 220 can include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some aspects, the one or more transceivers 220 can include a cellular subsystem, a WLAN subsystem, and/or a Bluetooth™ subsystem, each including its own radio transceiver and protocol(s) as will be understood by those skilled arts based on the discussion provided herein. In some implementations, the one or more transceivers 220 can include more or fewer systems for communicating with other devices.

In some examples, the one or more transceivers 220 can include one or more circuits (including a WLAN transceiver) to enable connection(s) and communication over WLAN networks such as, but not limited to, networks based on standards described in IEEE 802.11. Additionally, or alternatively, the one or more transceivers 220 can include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, transceiver 220n can include a Bluetooth™ transceiver.

Additionally, the one or more transceivers 220 can include one or more circuits (including a cellular transceiver) for connecting to and communicating on cellular networks. The cellular networks can include, but are not limited to, 3G/4G/5G networks such as Universal Mobile Telecommunications System (UMTS), Long-Term Evolution (LTE), and the like. For example, the one or more transceivers 220a-220n can be configured to operate according to one or more of Rel-15, Rel-16, Rel-17, Rel-17 NR, Rel-18, Rel-18 NR, or other of the 3GPP standards.

According to some aspects, the processor 210, alone or in combination with computer instructions stored within the memory 250, and/or the one or more transceiver 220, implements mechanisms for indicating and using antenna ports for enhanced DMRS, as discussed herein.

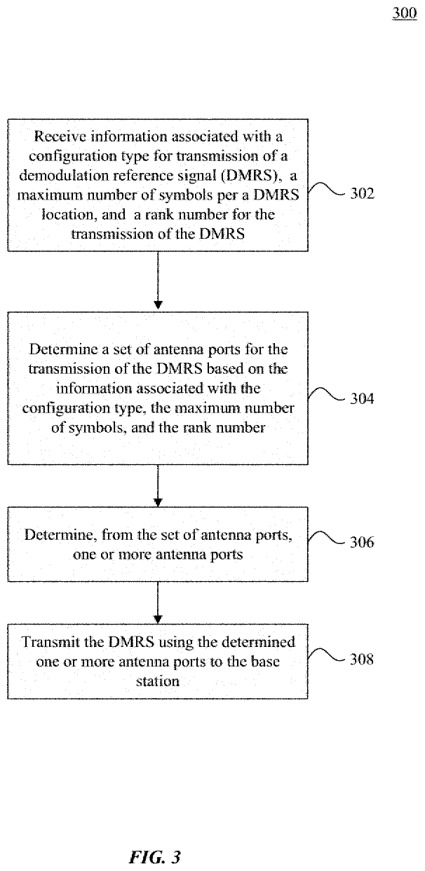

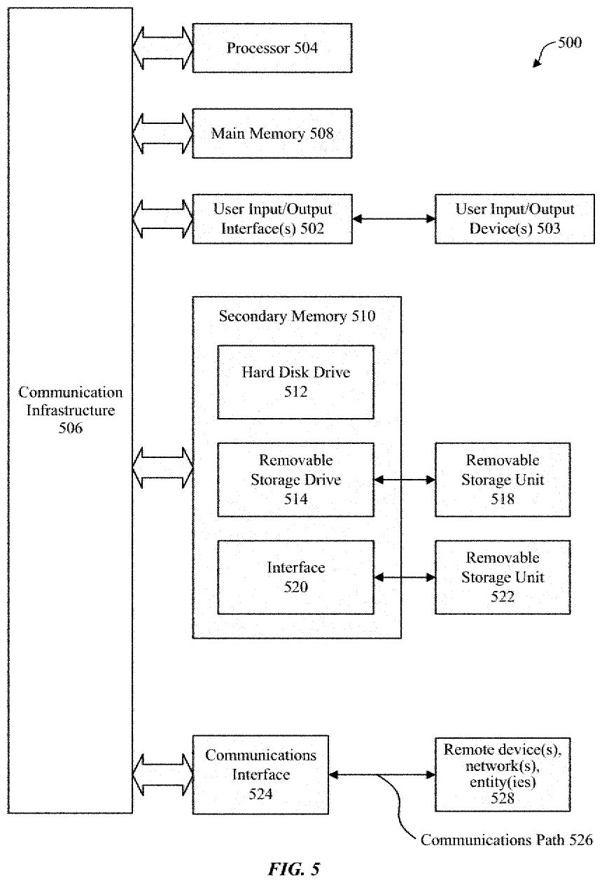

FIG. 3 illustrates an example method 300 for a system (for example, a UE) performing mechanisms for indicating and using antenna ports for enhanced DMR), according to some aspects of the disclosure. As a convenience and not a limitation, FIG. 3 may be described with regard to elements of FIGS. 1-2. Method 300 may represent the operation of an electronic device (for example, UE 103 of FIG. 1) implementing mechanisms for indicating and using antenna ports for enhanced DMRS. Method 300 may also be performed by system 200 of FIG. 2 and/or computer system 500 of FIG. 5. But method 300 is not limited to the specific aspects depicted in those figures and other systems may be used to perform the method as will be understood by those skilled in the art. It is to be appreciated that not all operations may be needed, and the operations may not be performed in the same order as shown in FIG. 3.

At 302, information associated with a configuration type for transmission of a demodulation reference signal (DMRS), a maximum number of symbols per a DMRS location, and a rank number for the transmission of the DMRS is received. For example, a UE (e.g., the UE 103) can receive the information associated with the configuration type for transmission of the DMRS, the maximum number of symbols per a DMRS location, and the rank number for the transmission of the DMRS from a base station (e.g., base station 101). The information associated with the configuration type, the maximum number of symbols, and the rank number for the transmission of the DMRS can include information associated with the configuration type, information associated with the maximum number of symbols per a DMRS location, and information associated with the rank number for the transmission of the DMRS.

In some aspects, the UE can receive the information associated with the configuration type and the maximum number of symbols per a DMRS location using radio resource control (RRC) configuration (e.g., an RRC message) from the base station. However, the aspects of this disclosure can include other methods for receiving the information associated with the configuration type and the maximum number of symbols.

The rank number can indicate the number of layers/ranks. In some aspects, the UE can receive the information associated with the rank number using a Downlink Control Information (DCI) message (e.g., DCI Format 0_0, DCI Format 0_1, and/or DCI Format 0_2). For example, for a non-codebook example (e.g., txConfig=nonCodebook), the rank number (the number of layers) and a precoding can be indicated by a “SRS resource indicator” field of the DCI message. For a codebook example (e.g., txConfig=codebook), the rank number (the number of layers) and the precoding can be indicated by a “precoding information and number of layers” field in the DCI message (e.g., DCI Format 0_1/0_2 scheduling the PUSCH). However, the aspects of this disclosure can include other methods for receiving the information associated with the rank number.

At 304, a set of antenna ports for the transmission of the DMRS is determined. For example, the UE can determine the set of antenna ports for the transmission of the DMRS. The UE can determine the set of antenna ports based at least on the information associated with the configuration type, the maximum number of symbols, and/or the rank number. For example, depending on the information associated with the configuration type, the information associated with the maximum number of symbols, and/or the information associated with the rank number, the UE can determine which one of Tables 1-13 discussed above to use. The set of antenna ports for the transmission of the DMRS can include Tables 1-13.

According to some aspects, the set of antenna ports for the transmission of the DMRS including Tables 1-13 is used for enhanced DMRS. As discussed above, the enhanced DMRS uses frequency division Orthogonal Cover Codes (FD-OCC) of length 4.

According to some aspects, the set of antenna ports can include one or more of a first subset of antenna ports, a second subset of antenna ports different from the first subset of antenna ports, or a combination of the first subset of antenna ports and a second subset of antenna ports.

For example, Table 1 discussed above includes enhanced antenna ports (e.g., the second subset of antenna ports). For example, Tables 2-4 discussed above include enhanced antenna ports (e.g., the second subset of antenna ports) and a combination of legacy antenna ports and enhanced antenna ports (e.g., a combination of the first subset of antenna ports and a second subset of antenna ports). For example, Table 5 discussed above includes a combination of legacy antenna ports and enhanced antenna ports (e.g., a combination of the first subset of antenna ports and a second subset of antenna ports).

For example, Table 6 discussed above includes enhanced antenna ports (e.g., the second subset of antenna ports). For example, Tables 7-9 discussed above include enhanced antenna ports (e.g., the second subset of antenna ports) and a combination of legacy antenna ports and enhanced antenna ports (e.g., a combination of the first subset of antenna ports and a second subset of antenna ports). For example, Tables 10-13 discussed above include legacy antenna ports (e.g., the first subset of antenna ports), enhanced antenna ports (e.g., the second subset of antenna ports), and a combination of legacy antenna ports and enhanced antenna ports (e.g., a combination of the first subset of antenna ports and a second subset of antenna ports).

According to some aspects, the information associated with the configuration type can include configuration Type 1. In these examples, the first subset of antenna ports can include one or more or a combination of antenna ports 0, 1, 2, 3, 4, 5, 6, and 7. The second subset of antenna ports can include one or more or a combination of antenna ports 8, 9, 10, 11, 12, 13, 14, and 15.

According to some aspects, the information associated with the configuration type can include configuration Type 2. In these examples, the first subset of antenna ports can include one or more or a combination of antenna ports 0, 1, 2, 3, 4, 5, 6, 7, 8, 9, 10, and 11. The second subset of antenna ports can include one or more or a combination of antenna ports 12, 13, 14, 15, 16, 17, 18, 19, 20, 21, 22, and 23.

According to some aspects, the DCI message include information indicating whether the UE is to use Tables 1-13 or use legacy tables 7.3.1.1.2-8/9/10/11/12/13/14/15/16/17/18/19/20/21/22 of TS 38.212. In these examples, system 100 of FIG. 1 can be applied to both enhanced UEs and legacy UEs. The enhanced UEs can be UEs that support the enhanced DMRS. The legacy UEs can be UEs that do no support the enhanced DMRS.

At 306, one or more antenna ports are selected from the determined set of antenna ports. For example, after the UE determines the set of antenna ports to use (e.g., Tables 1-13), then the UE can determine which one or more ports from the set of antenna ports to use. According to some aspects, the UE can receive a message from the base station indicating which one or more ports to use. In a non-limiting example, the message can include a DCI message (e.g., DCI Format 0_0, DCI Format 0_1, and/or DCI Format 0_2). Additionally, or alternatively, the message can include the RRC configuration message. However, the base station can use other message to indicate to the UE which one or more ports to use. In one example, the DCI message can include a field to indicate to the UE which one or more ports to use. For example, the DCI message can include a field that indicates a row in Tables 1-13 to indicate which one or more ports to use.

After determining the set of antenna ports using operations 302-306 and after receiving the indication from the base station, the UE can determine the one or more antenna ports.

At 308, the DMRS is transmitted using the selected one or more antenna ports. For example, the UE can transmit the DMRS to the base station using the determined one or more antenna ports.

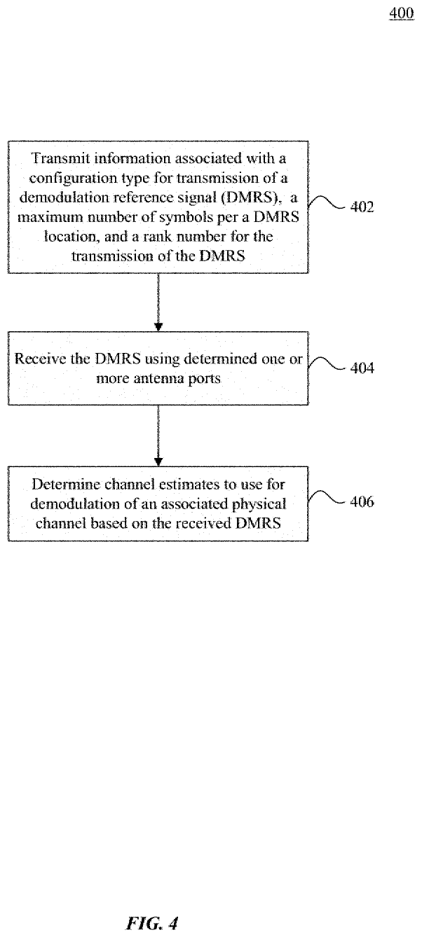

FIG. 4 illustrates an example method 400 for a system (for example, a base station) performing mechanisms for indicating and using antenna ports for enhanced DMRS, according to some aspects of the disclosure. As a convenience and not a limitation, FIG. 4 may be described with regard to elements of FIGS. 1-3. Method 400 may represent the operation of an electronic device (for example, base station 101 of FIG. 1) performing mechanisms for indicating and using antenna ports for enhanced DMRS. Method 400 may also be performed by system 200 of FIG. 2 and/or computer system 500 of FIG. 5. But method 400 is not limited to the specific aspects depicted in those figures and other systems may be used to perform the method as will be understood by those skilled in the art. It is to be appreciated that not all operations may be needed, and the operations may not be performed in the same order as shown in FIG. 4.

At 402, information associated with a configuration type for transmission of a demodulation reference signal (DMRS), a maximum number of symbols per a DMRS location, and a rank number for the transmission of the DMRS is transmitted. For example, a base station (e.g., base station 101) can transmit the information associated with the configuration type for transmission of the DMRS, the maximum number of symbols per a DMRS location, and the rank number for the transmission of the DMRS to a UE (e.g., the UE 103). The information associated with the configuration type, the maximum number of symbols, and the rank number for the transmission of the DMRS can include information associated with the configuration type, information associated with the maximum number of symbols per a DMRS location, and information associated with the rank number for the transmission of the DMRS

In some aspects, the base station can transmit the information associated with the configuration type and the maximum number of symbols using radio resource control (RRC) configuration (e.g., an RRC message). However, the aspects of this disclosure can include other methods for transmitting the information associated with the configuration type and the maximum number of symbols.

The rank number can indicate the number of layers/ranks. In some aspects, the base station can transmit the information associated with the rank number using a Downlink Control Information (DCI) message (e.g., DCI Format 0_0, DCI Format 0_1, and/or DCI Format 0_2). However, the aspects of this disclosure can include other methods for transmitting the information associated with the rank number.

At 404, the DMRS is received using determined one or more antenna ports. For example, the base station can receive the DMRS to from the UE using the determined one or more antenna ports. According to some aspects, the UE can determine the one or more antenna ports using operations 304 and 306 discussed above. For example, the UE can determine a set of antenna ports for the transmission of the DMRS. The UE can determine the set of antenna ports based at least on the information associated with the configuration type, the maximum number of symbols, and/or the rank number. For example, depending on the information associated with the configuration type, the maximum number of symbols, and/or the rank number, the UE can determine which one of Tables 1-13 discussed above to use. The set of antenna ports for the transmission of the DMRS can include Tables 1-13.

According to some aspects, method 400 can further include transmitting a message to the UE indicating which one or more ports to use. In a non-limiting example, the message can include a DCI message (e.g., DCI Format 0_0, DCI Format 0_1, and/or DCI Format 0_2). Additionally, or alternatively, the message can include the RRC configuration message. However, the base station can use other message to indicate to the UE which one or more ports to use. In one example, the DCI message can include a field to indicate to the UE which one or more ports to use. For example, the DCI message can include a field that indicates a row in Tables 1-13 to indicate which one or more ports to use.

At 406, channel estimates for use in demodulation of an associated physical channel are determined based on the received DMRS. For example, the base station can use the received DMRS to determine (e.g., produce) channel estimates for demodulation of associated physical channel. For example, the base station can use the received DMRS to determine (e.g., produce) channel estimates for demodulation of the PUSCH. The base station can use the received DMRS for decoding data transmitted on the PUSCH. Additionally, or alternatively, the base station can use the DMRS to determine the channel quality of the channel on which the DMRS was transmitted (e.g., the PUSCH).

Various aspects can be implemented, for example, using one or more computer systems, such as computer system 500 shown in FIG. 5. Computer system 500 can be any well-known computer capable of performing the functions described herein such as devices 101, 103 of FIG. 1, and/or 200 of FIG. 2. Computer system 500 includes one or more processors (also called central processing units, or CPUs), such as a processor 504. Processor 504 is connected to a communication infrastructure 506 (e.g., a bus). Computer system 500 also includes user input/output device(s) 503, such as monitors, keyboards, pointing devices, etc., that communicate with communication infrastructure 506 through user input/output interface(s) 502. Computer system 500 also includes a main or primary memory 508, such as random access memory (RAM). Main memory 508 may include one or more levels of cache. Main memory 508 has stored therein control logic (e.g., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/any other computer data storage device. Removable storage drive 514 reads from and/or writes to removable storage unit 518 in a well-known manner.

According to some aspects, secondary memory 510 may include other means, instrumentalities or other approaches for allowing computer programs and/or other instructions and/or data to be accessed by computer system 500. Such means, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 500, main memory 508, secondary memory 510 and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 5. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more, but not all, exemplary aspects of the disclosure as contemplated by the inventor(s), and thus, are not intended to limit the disclosure or the appended claims in any way.

While the disclosure has been described herein with reference to exemplary aspects for exemplary fields and applications, it should be understood that the disclosure is not limited thereto. Other aspects and modifications thereto are possible, and are within the scope and spirit of the disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. In addition, alternative aspects may perform functional blocks, steps, operations, methods, etc. using orderings different from those described herein.

References herein to “one aspect,” “aspects” “an example,” “examples,” or similar phrases, indicate that the aspect(s) described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein.

The breadth and scope of the disclosure should not be limited by any of the above-described exemplary aspects, but should be defined only in accordance with the following claims and their equivalents.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should only occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of, or access to, certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

What is claimed is:

1. A user equipment (UE), comprising:
a transceiver configured to wirelessly communicate with a base station; and
a processor communicatively coupled to the transceiver and configured to:
receive, using the transceiver, information associated with a configuration type for transmission of a demodulation reference signal (DMRS), a maximum number of symbols per a DMRS location, and a rank number for the transmission of the DMRS; and
determine a set of antenna ports for the transmission of the DMRS based on the information associated with the configuration type, the maximum number of symbols, and the rank number,
wherein the DMRS uses frequency division Orthogonal Cover Codes (FD-OCC) of length 4, and
wherein the set of antenna ports comprises one or more of a first subset of antenna ports, a second subset of antenna ports different from the first subset of antenna ports, or a combination of the first subset of antenna ports and a second subset of antenna ports.

2. The UE of claim 1, wherein:
the information associated with the configuration type comprises configuration Type 1,
the first subset of antenna ports comprises one or more or a combination of antenna ports 0, 1, 2, 3, 4, 5, 6, and 7, and
the second subset of antenna ports comprises one or more or a combination of antenna ports 8, 9, 10, 11, 12, 13, 14, and 15.

3. The UE of claim 1, wherein:
the information associated with the configuration type comprises configuration Type 2,
the first subset of antenna ports comprises one or more or a combination of antenna ports 0, 1, 2, 3, 4, 5, 6, 7, 8, 9, 10, and 11, and
the second subset of antenna ports comprises one or more or a combination of antenna ports 12, 13, 14, 15, 16, 17, 18, 19, 20, 21, 22, and 23.

4. The UE of claim 1, wherein the processor is configured to:
receive, using the transceiver, the information associated with the configuration type and the maximum number of symbols using radio resource control (RRC) configuration from the base station.

5. The UE of claim 1, wherein the processor is configured to receive, using the transceiver, the information associated with the rank number using a Downlink Control Information (DCI) message.

6. The UE of claim 1, wherein the processor is further configured to:
determine, from the set of antenna ports, one or more antenna ports; and
transmit, using the transceiver and to the base station, the DMRS using the determined one or more antenna ports.

7. The UE of claim 6, wherein the processor is further configured to receive, using the transceiver and from the base station, an indication of the one or more antenna ports.

8. A method performed by a user equipment (UE), the method comprising:
receiving information associated with a configuration type for transmission of a demodulation reference signal (DMRS), a maximum number of symbols per a DMRS location, and a rank number for the transmission of the DMRS; and
determining a set of antenna ports for the transmission of the DMRS based on the information associated with the configuration type, the maximum number of symbols, and the rank number,
wherein the DMRS uses frequency division Orthogonal Cover Codes (FD-OCC) of length 4, and
wherein the set of antenna ports comprises one or more of a first subset of antenna ports, a second subset of antenna ports different from the first subset of antenna ports, or a combination of the first subset of antenna ports and a second subset of antenna ports.

9. The method of claim 8, wherein:
the information associated with the configuration type comprises configuration Type 1,
the first subset of antenna ports comprises one or more or a combination of antenna ports 0, 1, 2, 3, 4, 5, 6, and 7, and
the second subset of antenna ports comprises one or more or a combination of antenna ports 8, 9, 10, 11, 12, 13, 14, and 15.

10. The method of claim 8, wherein:
the information associated with the configuration type comprises configuration Type 2,
the first subset of antenna ports comprises one or more or a combination of antenna ports 0, 1, 2, 3, 4, 5, 6, 7, 8, 9, 10, and 11, and
the second subset of antenna ports comprises one or more or a combination of antenna ports 12, 13, 14, 15, 16, 17, 18, 19, 20, 21, 22, and 23.

11. The method of claim 8, further comprising:
receiving the information associated with the configuration type and the maximum number of symbols using radio resource control (RRC) configuration from the base station.

12. The method of claim 8, further comprising:
receiving the information associated with the rank number using a Downlink Control Information (DCI) message.

13. The method of claim 8, further comprising:
determining, from the set of antenna ports, one or more antenna ports; and
transmitting, to the base station, the DMRS using the determined one or more antenna ports.

14. The method of claim 13, further comprising:
receiving, and from the base station, an indication of the one or more antenna ports.

15. A non-transitory computer-readable medium storing instructions that when executed by a processor of a user equipment (UE) cause the UE to perform operations comprising:
receiving information associated with a configuration type for transmission of a demodulation reference signal (DMRS), a maximum number of symbols per a DMRS location, a rank number for the transmission of the DMRS; and
determining a set of antenna ports for the transmission of the DMRS based on the information associated with the configuration type, the maximum number of symbols, and the rank number,
wherein the DMRS uses frequency division Orthogonal Cover Codes (FD-OCC) of length 4, and
wherein the set of antenna ports comprises one or more of a first subset of antenna ports, a second subset of antenna ports different from the first subset of antenna ports, or a combination of the first subset of antenna ports and a second subset of antenna ports.

16. The non-transitory computer-readable medium of claim 15, wherein:
the information associated with the configuration type comprises configuration Type 1,
the first subset of antenna ports comprises one or more or a combination of antenna ports 0, 1, 2, 3, 4, 5, 6, and 7, and
the second subset of antenna ports comprises one or more or a combination of antenna ports 8, 9, 10, 11, 12, 13, 14, and 15.

17. The non-transitory computer-readable medium of claim 15, wherein:
the information associated with the configuration type comprises configuration Type 2,
the first subset of antenna ports comprises one or more or a combination of antenna ports 0, 1, 2, 3, 4, 5, 6, 7, 8, 9, 10, and 11, and
the second subset of antenna ports comprises one or more or a combination of antenna ports 12, 13, 14, 15, 16, 17, 18, 19, 20, 21, 22, and 23.

18. The non-transitory computer-readable medium of claim 15, the operations further comprising:
receiving the information associated with the configuration type and the maximum number of symbols using radio resource control (RRC) configuration from the base station.

19. The non-transitory computer-readable medium of claim 15, the operations further comprising:
receiving the information associated with the rank number using a Downlink Control Information (DCI) message.

20. The non-transitory computer-readable medium of claim 15, the operations further:
receiving, and from the base station, an indication of the one or more antenna ports;
determining, from the set of antenna ports, the one or more antenna ports; and
transmitting, to the base station, the DMRS using the determined one or more antenna ports.
